(19) United States
(12) Patent Application Publication
(10) Pub. No.: US 2013/0193835 A1
(43) Pub. Date: Aug. 1, 2013

(54) FLUORESCENT LAMP WITH COATED PHOSPHOR PARTICLES

(71) Applicants: William Erwin COHEN, Cleveland, OH (US); William BEERS, Chesterland, OH (US); Alok SRIVASTAVA, Niskayuna, NY (US); Laszlo BALAZS, Budapest (HU); Istvan DEME, Budapest (HU)

(72) Inventors: William Erwin COHEN, Cleveland, OH (US); William BEERS, Chesterland, OH (US); Alok SRIVASTAVA, Niskayuna, NY (US); Laszlo BALAZS, Budapest (HU); Istvan DEME, Budapest (HU)

(73) Assignee: GENERAL ELECTRIC COMPANY, Schenectady, NY (US)

(21) Appl. No.: 13/361,278

(22) Filed: Jan. 30, 2012

(51) Int. Cl. H01J 61/44

(52) U.S. Cl. 313/487; 313/486

(57) ABSTRACT

This disclosure features fluorescent lamps that include a phosphor layer including at least one phosphor, which in the past has not been commercially usable in lamps or in some cases suffers from performance problems such as poor brightness. These problems of the phosphors were caused, for example, by mercury ion bombardment or exposure to 185 nm radiation from the discharge. These problems are expected to be avoided by coating particles of one or more of the phosphors, such as using atomic layer deposition in which the coating is not more than 500 nm in thickness. Examples of phosphors that can be coated are yttrium vanadate activated with europium or yttrium vanadate phosphate activated with europium. The coating can be selected from the group consisting of alumina, yttria, lanthanum oxide, magnesium aluminate spinel, magnesium oxide and combinations thereof.

### FIELD OF THE INVENTION

This disclosure pertains to a fluorescent lamp including a coated phosphor, in particular, to a lamp including at least one phosphor that has a thin coating applied using atomic layer deposition.

### BACKGROUND OF THE INVENTION

Fluorescent lamps are well known and comprise a tubular hermetically sealed glass envelope including electrodes at ends thereof. Inside the envelope is an arc discharge sustaining medium, usually at a low pressure, including inert gases and a small amount of mercury. The inside of the glass envelope is typically coated with a layer of phosphor, which absorbs ultraviolet electromagnetic radiation of 254 nm and 185 nm generated by the excited mercury arc and emits in a region of visible light.

Fluorescent lamps usually experience a gradual decrease in light output (measured in lumens) with the increase of lamp usage (measured in hours burned). Ideally, the phosphor should absorb the 254 nm and 185 nm emission strongly and convert them into visible light efficiently. But in reality, most of the 185 nm wavelength radiation is wasted, which lowers the overall efficiency of the lamp. Moreover, 185 nm emission also leads to formation of color center—a type of point defect-in phosphors, which decreases the phosphor conversion efficiency and lumen output of lamps over their life cycle. There are other notable problems associated with phosphors in fluorescent lamps. The phosphor coating is exposed to both ion bombardment and chemical reaction from the mercury discharge which is a reducing medium. In addition, during phosphor synthesis and lamp fabrication process, phosphors are usually exposed to oxygen-rich atmosphere which tend to partially oxidize reactive lower-valence ions in the phosphor lattice. These problems lead to the overall degradation of phosphors and their lumen output over life.

Yttrium vanadate phosphors (e.g., YVO₄:Eu³⁺, Y(P,V)O₄:Eu³⁺) strongly emitting in the deep red region, have been widely utilized in high pressure mercury lamps, and have greatly improved color rendering properties of these lamps. However, it is our understanding that they have been excluded from current commercial use in fluorescent lamp manufacturing because of their very severe lumen depreciation during lamp operation.

The apparent color of a light source is described in terms of color temperature, which is the temperature of a black body that emits radiation of about the same chromaticity as the radiation considered. A light source having a color temperature of 3000 Kelvin has a larger red component than a light source having a color temperature of 4100 Kelvin. The color temperature of a lamp using a phosphor blend can be varied by changing the ratio of the phosphors.

Color quality is further described in terms of color rendering, and more particularly color rendering index (CRI or Rₐ), which is a measure of the degree to which the psycho-physical colors of objects illuminated by a light source conform to those of a reference illuminant for specified conditions. CRI is in effect a measure of how well the spectral distribution of a light source compares with that of an incandescent (blackbody) source, which has a Planckian distribution between the infrared (over 700 nm) and the ultraviolet (under 400 nm). The discrete spectra which characterize phosphor blends will yield good color rendering of objects whose colors match the spectral peaks, but not as good of objects whose colors lie between the spectral peaks.

Color rendition is a measure of the light reflected by a color sample under a given light source, compared to the light reflected by the same sample under a standard light source. Color rendition is calculated as disclosed in “Method of Measuring and Specifying Colour Rendering Properties of Light Sources, 2nd Edition”, International Commission on Illumination, Publication CIE No. 13.2 (TC-3.2) 1974, the contents of which are hereby incorporated by reference. The differences in value, chroma and hue of the light reflected under the two sources are measured and summed, the square root of the sum is taken, multiplied by a constant, and subtracted from 100. This calculation is done for 14 different color standards. The color rendering index for each of these standards is designated Rᵢ. The General Color Rendering Index, Rₐ, is defined as the average of the first eight indices, R₁-R₈. The constant has been chosen such that Rₐ for a standard warm white fluorescent tube is approximately 50. It should be noted that an Rₐ of 100 corresponds to a light source under which the color samples appear exactly as they would under a standard light source, such as an incandescent (black body) lamp or natural daylight.

The color appearance of a lamp is described by its chromaticity coordinates which can be calculated from the spectral power distribution according to standard methods. See CIE, Method of measuring and specifying color rendering properties of light sources (2nd ed.), Publ. CIE No. 13.2 (TC-3, 2), Bureau Central de la CIE, Paris, 1974. The CIE standard chromaticity diagram includes the color points of black body radiators at various temperatures. The locus of black body chromaticities on the x,y-diagram is known as the Planckian locus. Any emitting source represented by a point on this locus may be specified by a color temperature. A point near but not on this Planckian locus has a correlated color temperature (CCT) because lines can be drawn from such points to intersect the Planckian locus at this color temperature such that all points look to the average human eye as having nearly the same color. Luminous efficacy of a source of light is the quotient of the total luminous flux emitted by the total lamp power input as expressed in lumens per watt (LPW).

### BRIEF DESCRIPTION OF THE INVENTION

A first embodiment of this disclosure features a fluorescent lamp comprising an envelope that is light transmitting. Means for providing a discharge is disposed inside the envelope. A discharge-sustaining fill of mercury and an inert gas is sealed inside the envelope. A phosphor-containing layer is coated inside the envelope. The phosphor-containing layer is comprised of particles comprising phosphor selected from the group consisting of: zinc germanium silicate; strontium aluminate; strontium fluorophosphate; strontium magnesium orthophosphate; barium magnesium aluminate; yttrium vanadate, and combinations thereof and a coating on individual particles of at least one of the phosphor, the coating being selected from the group consisting of alumina, yttria, lanthanum oxide, magnesium aluminate spinel, magnesium oxide, and combinations thereof.

In all embodiments herein when a phosphor is referred to in this disclosure it means the host compound (e.g., strontium aluminate) and at least one activator or dopant (e.g., europium for the strontium aluminate), and all combinations of possible activators or dopants, for the host compound. All of the phosphors described in this disclosure may also include trace amounts of activator or dopant. For example, YVP:Eu might include about 100 ppm Tb. Tb is sometimes added to YVP to reduce color center formation, for instance.

Referring to specific features of the first embodiment, the yttrium vanadate can comprise yttrium vanadate activated with europium, yttrium vanadate phosphate activated with europium, and combinations thereof. The zinc germanium silicate can comprise zinc germanium silicate activated with manganese; the strontium aluminate can comprise strontium aluminate activated with europium; the strontium fluorophosphate can comprise strontium fluorophosphate activated with antimony and manganese; the strontium magnesium orthophosphate can comprise strontium magnesium orthophosphate activated with tin; and the barium magnesium aluminate can comprise barium magnesium aluminate activated with europium or barium magnesium aluminate activated with europium and manganese.

The following refers to specific features applicable to all embodiments. The coating can comprise magnesium aluminate spinel when any of the above phosphors are used or, in particular, when the coated phosphor is yttrium vanadate. The means for providing a discharge inside the envelope can comprise electrodes spaced apart from each other and disposed at ends of the envelope. The coating on the phosphor particles can have a thickness of not more than 500 nm, or not more than 100 nm. The coating can be carried out using atomic layer deposition (ALD). Other phosphors can also be used in combination with the phosphors listed above, which may or may not be ALD coated.

A second embodiment of this disclosure features the lamp described above except the phosphor-containing layer is comprised of the following blend of phosphors: yttrium vanadate and at least one phosphor selected from the group consisting of barium magnesium aluminate, (barium, strontium or calcium)chloroapatite, strontium aluminate, halophosphate and combinations thereof; and a coating on individual particles of the blend that are comprised of the yttrium vanadate. The coating includes a compound that is selected from the group consisting of alumina, yttria, lanthanum oxide, magnesium aluminate spinel, magnesium oxide and combinations thereof. The coating can be made by atomic layer deposition. This lamp can have a blue-red emission.

Regarding specific aspects of the second embodiment, the yttrium vanadate comprises at least one of yttrium vanadate activated with europium, yttrium vanadate phosphate activated with europium, and combinations thereof; and/or the barium magnesium aluminate comprises at least one of barium magnesium aluminate activated with europium (BAM) and barium magnesium aluminate activated with europium and manganese (BAMn); the strontium aluminate comprises strontium aluminate activated with europium (Sr₄Al₁₄O₂₅:Eu); the halophosphate comprises Ca₁₀(PO₄)₆(F,Cl)₂:Sb,Mn; where one or both of Cl and Mn may be zero, this composition including F and/or Cl, and the (barium, strontium or calcium)chloroapatite comprises barium, strontium or calcium chloroapatite activated with europium (SECA). The ALD coating can also be used on any of the other phosphors listed in the second embodiment.

A third embodiment features the lamp described above except that the phosphor-containing layer is comprised of the following blend of phosphors:

at least one of yttrium vanadate activated with europium or yttrium vanadate phosphate activated with europium;

at least one first phosphor selected from the group consisting of barium magnesium aluminate activated with europium (BAM), barium magnesium aluminate activated with europium and manganese (BAMn), (barium, strontium or calcium)chloroapatite activated with europium (SECA), strontium aluminate activated with europium, halophosphate and combinations thereof; and

at least one second phosphor selected from the group consisting of lanthanum phosphate activated with cerium and terbium (LAP), magnesium cerium aluminate phosphor activated with terbium (CAT), gadolinium magnesium borate activated with cerium and terbium (CBT), barium magnesium aluminate activated with europium and manganese (BAMn), and combinations thereof; and

a coating on individual particles of the blend that are comprised of the yttrium vanadate activated with europium or the yttrium vanadate phosphate activated with europium, or a combination thereof. The coating is selected from the group consisting of alumina, yttria, lanthanum oxide, magnesium aluminate spinel, magnesium oxide and combinations thereof. The coating can be made by atomic layer deposition. This lamp can have a white emission. The ALD coating can also be used on one or more of the first and second phosphors of the third embodiment.

A fourth embodiment features the lamp as described above except that the phosphor-containing layer is comprised of the following blend of phosphors:

at least one of yttrium vanadate activated with europium or yttrium vanadate phosphate activated with europium; and at least one of the following first and second phosphors:

at least one first phosphor having a blue emission peak in the range of 400-460 nm; and

at least one second phosphor having a green emission peak in the range of 500-560 nm; and

a coating on individual particles of the blend that are comprised of the yttrium vanadate activated with europium or the yttrium vanadate phosphate activated with europium, or a combination thereof, the coating being selected from the group consisting of alumina, yttria, lanthanum oxide, magnesium aluminate spinel, magnesium oxide and combinations thereof. The coating can be made by atomic layer deposition. This lamp can have a white emission. The ALD coating can also be used on one or more of the first and second phosphors of the fourth embodiment.

Many additional features, advantages and a fuller understanding of the invention will be had from the accompanying drawings and the Detailed Description of the Invention that follows. It should be understood that the above Brief Description of the Invention describes the invention in broad terms while the following Detailed Description of the Invention describes the invention more narrowly and presents embodiments that should not be construed as necessary limitations of the broad invention as defined in the claims.

### BRIEF DESCRIPTION OF THE DRAWINGS

FIG. 1 shows diagrammatically, and partially in section, a fluorescent lamp made according to this disclosure.

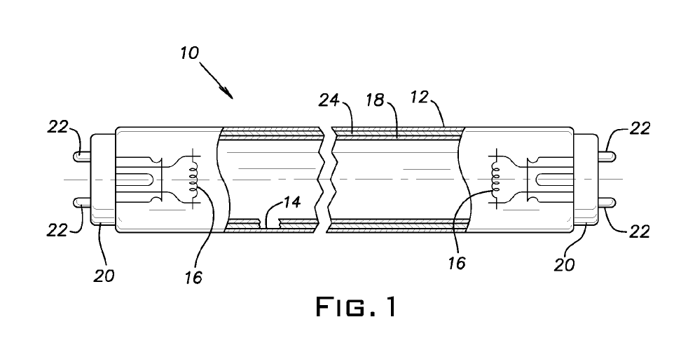

### DETAILED DESCRIPTION OF THE INVENTION

This disclosure features a fluorescent lamp with improved performance using at least one phosphor that conventionally in some cases has had performance problems such that if the phosphor has been used in a fluorescent lamp at all, the phosphor has exhibited deleterious interactions within the operating lamp. For example, the phosphor, yttrium vanadate phosphate (YVP) has relatively low lumens per watt when used in a comparative lamp but a favorable average CRI for color levels R1-R8 (i.e., Rₐ) and a favorable value for an R9 color level for deep red. Due to this problem, it is believed that YVP has not been commercially used in fluorescent lamps until the present disclosure. All of the uncoated phosphors disclosed herein suffer from defects caused by interaction with radiation at a wavelength of 185 nm. In addition, the uncoated phosphors, yttrium vanadate activated with europium and yttrium vanadate phosphate activated with europium, suffer from mercury ion bombardment. Each of the fluorescent lamps of this disclosure includes a glass envelope that is covered with a layer of particles of at least one phosphor; the particles of one phosphor, or possibly more than one phosphor if multiple phosphors are used, have been individually coated with a very thin coating made by atomic layer deposition (ALD) to protect or isolate the phosphor particles. The ability to use the particular phosphors disclosed herein in fluorescent lamps exhibiting improved performance may offer a cost savings versus other current options that do not employ phosphors that have these same deleterious interactions.

The fluorescent lamp 10 has a light-transmissive glass tube or envelope 12 which has a circular cross-section. The inner surface 14 of the glass envelope is provided with a phosphor-containing layer 18.

The lamp is hermetically sealed by bases 20 attached at both ends, and a pair of spaced electrode structures 16 at each end of the lamp (which are means for providing a discharge) are respectively mounted on the bases 20. As will be familiar to those having ordinary skill in the art, the electric current is delivered to the electrode structures through the pins 22 which are held in lamp sockets or holders not shown that are connected to an electric circuit that includes a source of electric power. A discharge-sustaining fill of mercury and an inert gas is sealed inside the glass tube. The inert gas is typically argon or a mixture of argon and other noble gases at low pressure which, in combination with a small quantity of mercury, provide the low vapor pressure manner of operation.

The phosphor-containing layer 18 is preferably utilized in a low pressure mercury vapor discharge lamp, but may also be used in a high pressure mercury vapor discharge lamp. As used herein, a “fluorescent lamp” is any mercury vapor discharge fluorescent lamp as known in the art, including fluorescent lamps having electrodes, and electrodeless fluorescent lamps where the means for providing a discharge include a radio transmitter adapted to excite mercury vapor atoms via transmission of an electromagnetic signal. A “T8 lamp” can be used in this disclosure and is a fluorescent lamp as known in the art, e.g., linear, nominally 48 inches in length, and having a nominal outer diameter of 1 inch (eight times ⅛ inch, which is where the “8” in “T8” comes from). The T8 fluorescent lamp can also be nominally 2, 3, 6 or 8 feet long, or some other length. T5 and T12 fluorescent lamps known in the art can also utilize the coated phosphors of this disclosure. The fluorescent lamp can have a “non-straight glass envelope” which includes (but is not limited to) a glass envelope or tube which is in the shape of an L or a U (such as a 4 foot T8 or T12 lamp bent into a U-shape), a circular glass envelope as is known in the art, the glass envelope of a compact fluorescent lamp (e.g., a helical compact fluorescent lamp), and other glass envelopes which are not a straight cylindrical glass envelope. Compact fluorescent lamps are well known; see U.S. Pat. Nos. 2,279,635; 3,764,844; 3,899,712; 4,503,360; 5,128,590; 5,243,256; 5,451,104; and German Patent Application No. DE 4133077 filed in Germany on Oct. 2, 1991.

This disclosure features a lamp that employs phosphor particles of at least one phosphor that have been coated, using the ALD process, with a very thin layer of alumina (Al₂O₃), yttria (Y₂O₃), lanthanum oxide (La₂O₃), magnesium aluminate spinel (MgAl₂O₄), or magnesium oxide (MgO), or combinations thereof, to protect or isolate the phosphor. The phosphor coating can be applied once or two or more times, using one or more of the coating materials, alone or in combination, for each layer or for the different layers of the coating.

### Phosphors to be Coated

Phosphors that are ALD coated and used in a lamp of this disclosure are selected from the group consisting of: zinc germanium silicate activated with manganese (e.g., Zn₂(Si,Ge)O₄:Mn²⁺); strontium aluminate activated with europium (e.g., Sr₄Al₁₄O₂₅:Eu²⁺) or SAE; strontium fluorophosphate activated with antimony and manganese (e.g., Sr₅(PO₄)₃F:Sb³⁺,Mn²⁺); strontium magnesium orthophosphate activated with tin (e.g., (Sr,Mg)₃(PO₄)₂:Sn²⁺); barium magnesium aluminate activated with europium (e.g., BaMgAl₁₀O₁₇:Eu²⁺) or BAM; barium magnesium aluminate activated with europium and manganese (e.g., BaMgAl₁₀O₁₇:Eu²⁺,Mn²⁺) or BAMn; yttrium vanadate activated with europium (e.g., YVO₄:Eu³⁺); yttrium vanadate phosphate activated with europium (Y(P,V)O₄:Eu³⁺), and combinations thereof. It is possible that related phosphors having other activators or nonstoichiometry may be used in lamps of this disclosure. The above phosphors have previously not been commercially used in fluorescent lamps (e.g., the two yttrium vanadate phosphors) or in some cases have been used in fluorescent lamps with reduced performance. Therefore, the fluorescent lamps of this disclosure advance the technology in protectively coating in some cases previously deficient phosphors in fluorescent lamps operating with improved or as yet not seen properties. When more than one phosphor is used in a lamp, one or more of them may be ALD coated. Other phosphors that are not listed here may also be used in the lamp and may or may not be ALD coated.

Yttrium vanadate activated with europium and yttrium vanadate phosphate activated with europium mainly suffer from reactions with mercury ion bombardment. The rest of the phosphors listed above suffer from the problem of defects caused by exposure to radiation having a wavelength peak at 185 nm. Therefore, while not wanting to be bound by theory it is believed that the effect of the coatings on at least some of the above phosphors is to block the 185 nm radiation from reaching the phosphor particles. The listed phosphors may have limited use in conventional fluorescent lamps, if they are used at all, due to the lumen performance being significantly impacted by the operating fluorescent lamp plasma discharge. By ALD treating these phosphors with alumina, yttria, lanthanum oxide, magnesium aluminate spinel, magnesium oxide, or combinations thereof, to minimize this performance degradation, these phosphors might be used in applications where they offer better performance in either measured lamp performance specification and/or costs, e.g., compared to fluorescent lamps that employ rare earth phosphors or a greater proportion of rare earth phosphors. The presence of the ALD coating on the phosphor is expected to yield improved lumen maintenance, improved phosphor utilization, reduced mercury consumption, and improved lamp appearance.

A blue-red lamp may have useful applications such as a “grow-in-show” lamp for growing African violets or for meat lamps. In this regard the phosphor layer of the lamp may be a blend of phosphors comprising:

at least one of yttrium vanadate activated with europium or yttrium vanadate phosphate activated with europium (red emitting); and

at least one phosphor selected from the group consisting of barium magnesium aluminate activated with europium (BAM), barium magnesium aluminate activated with europium and manganese (BAMn), (barium, strontium or calcium)chloroapatite activated with europium (Ba, Sr, Ca)₁₀(PO₄)₆Cl₂:Eu (SECA), strontium aluminate activated with europium (Sr₄Al₁₄O₂₅:Eu), halophosphate (Ca₁₀(PO₄)₆(F,Cl)₂:Sb,Mn; where one or both of Cl and Mn may be zero) and combinations thereof (blue emitting).

Some examples of target blends are as follows. YV 40%, SECA1 20%, SECA2 40%; and YV 50%, BAM 31%, BAMn 19%, which should provide approximately the same. CCT as Grow-n-show lamps (approximately 7000K). Another example is a “grocery lamp” having a CCT of about 2800K; this composition is YV 67%, BAM 6% and BAMn 27%. These percentages are spectral fractions as described in the example.

SECA ((Ba, Sr, Ca)₁₀(PO₄)₆Cl₂:Eu) can be made in several shades of blue to blue-green. Color is varied by adjusting the Ba/Sr/Ca amounts. The ccx,ccy of SECA1 described herein is 0.156, 0.080 and of SECA2 described herein is 0.193, 0.302. Also, BAMn is made in various shades of blue-green. These fractions assume the “greenest” of these shades. All blues are commercially available.

There is an ALD coating on individual particles of the blend that are comprised of the yttrium vanadate activated with europium and/or the yttrium vanadate phosphate activated with europium. The coating comprises a compound that is selected from the group consisting of alumina, yttria, lanthanum oxide, magnesium aluminate spinel, magnesium oxide and combinations thereof.

Further, this disclosure also pertains to unique white blends of phosphors. In this regard the phosphor layer of the lamp may be a blend of phosphors comprising:

at least one of yttrium vanadate activated with europium or yttrium vanadate phosphate activated with europium (red emitting);

at least one first phosphor selected from the group consisting of barium magnesium aluminate activated with europium (BAM), barium magnesium aluminate activated with europium and manganese (BAMn), (barium, strontium or calcium)chloroapatite activated with europium (SECA), strontium aluminate activated with europium (Sr₄Al₁₄O₂₅:Eu), halophosphate (Ca₁₀(PO₄)₆(F,Cl)₂:Sb,Mn; where one or both of Cl and Mn may be zero) and combinations thereof (blue emitting); and

at least one second phosphor selected from the group consisting of lanthanum phosphate activated with cerium and terbium (LAP), magnesium cerium aluminate phosphor activated with terbium (CAT), gadolinium magnesium borate activated with cerium and terbium (CBT), barium magnesium aluminate activated with europium and manganese (BAMn), and combinations thereof (green emitting). BAMn, depending on the Eu/Mn ratio, can vary between “bluish green” and “greenish blue” and so it can be used in compositions of this disclosure where either blue or green is desired.

There is an ALD coating on individual particles of the blend that are comprised of the yttrium vanadate activated with europium or the yttrium vanadate phosphate activated with europium. The coating comprises a compound that is selected from the group consisting of alumina, yttria, lanthanum oxide, magnesium aluminate spinel, magnesium oxide and combinations thereof.

In the case of the white phosphor blend or the blue-red phosphor blend discussed above, yttrium vanadate phosphors of this disclosure can be used as the red phosphor with the other phosphors being any phosphor that produces a green emission peak in the range of 500-560 nm; and/or any phosphor that produces a blue emission peak in the range of 400-460 nm.

### Phosphor Blends Having CCT of 3500 K

The following are examples of phosphor compositions having a color temperature of about 3500 K (CCT) and ccx, ccy color points of 0.413, 0.393 that are suitable for use in the lamps of this disclosure or for comparison purposes where indicated. All percentages used in this disclosure are spectral percent, obtained as described in the Example below.

A standard blend of: Y₂O₃:Eu³⁺(YEO) 44%; LAP 46% and BAM 10% is described for comparative purposes. This is expected to result in a lamp coated with this blend having the following properties: about 93 LPW, with Ra about 86 and R9 about 10. All of the properties given for these 3500K compositions (and 3000 K compositions below) are at 100 hour lamp burning. All of these phosphor blends are white.

A YVP blend of: YVP 48%; LAP 44% and BAM 8%. This is expected to result in a lamp coated with this blend having the following properties: about 85 LPW with Ra about 87 but R9 now about 75.

A blend is achieved by combining YEO and YVP:YEO 13%; YVP 35%; LAP 45%; BAM 9%. This is expected to result in a lamp coated with this blend having the following properties: LPW about 87, Ra about 87, R9 about 55.

Another blend is achieved with addition of BAMn to the blend: YEO 37%; YVP 11%; LAP 39%; BAMn 5%; BAM 9%. This is expected to result in a lamp coated with this blend having the following properties: LPW about 90; Ra about 88 and R9 about 34.

### Phosphor Blends Having CCT of 3000 K

The following are examples of phosphor compositions having a color temperature of about 3000 K (CCT) and ccx, ccy color points of 0.440, 0.403 that are suitable for use in the lamps of this disclosure or for comparison purposes where indicated.

A standard blend of: YEO 49%; LAP 45%; and BAM 6%. This is expected to result in a lamp coated with this blend having the following properties: about 94 LPW, with Ra about 86 and R9 about 5

A similar YVP blend of: YVP 54%; LAP 41%; and BAM 5%. This is expected to result in a lamp coated with this blend having the following properties: about 84 LPW with Ra about 87 but R9 now about 68.

A blend is achieved by combining YEO and YVP:YEO 18%; YVP 35%; LAP 42%; BAM 5%. This is expected to result in a lamp coated with this blend having the following properties: LPW about 87, Ra about 87, R9 about 44.

All of the foregoing blends are based on modeling.

### The ALD Process

The following ALD process, in which very thin coatings are used to protectively coat the particles of one or more phosphors described herein, is described in published U.S. patent application No. 2010/0151249, text from which is incorporated into this disclosure, except without paragraph numbering from that publication.

“The atomic layer deposition process is characterized in that at least two different reactants are needed to form the coating layer. The reactants are introduced into the reaction zone individually, sequentially and in the gas phase. Excess amounts of reactant are removed from the reaction zone before introducing the next reactant. Reaction by-products are removed as well, between introductions of the reagents. This procedure ensures that reactions occur at the surface of the phosphor particles, rather than in the gas phase. Gas phase reactions, such as occur in chemical vapor deposition processes, are undesirable for several reasons. CVD reactions tend to cause particle agglomeration, form uneven and non-conformal coatings, and use greater amounts of raw materials than desired.

A purge gas is typically introduced between the alternating feeds of the reactants, in order to further help to remove excess reactants. A carrier gas, which is usually but not necessarily the same as the purge gas, generally is introduced during the time each reactant is introduced. The carrier gas may perform several functions, including (1) facilitating the removal of excess reactant and reaction by-products, (2) distributing the reactant through the reaction zone, thereby helping to expose all particle surfaces to the reactant and (3) fluidizing the phosphor particles so that all particle surfaces become exposed to the reactant.

A typical pattern of introducing reactants (in a two-reagent ALD reaction scheme) is: 1. Introduce purge/fluidizing gas. 2. Introduce mixture of carrier gas and first reagent. 3. Introduce purge/fluidizing gas and/or pull a high vacuum to remove excess quantities of the first reagent as well as reaction by-products. 4. Introduce mixture of carrier gas and second reagent. 5. Introduce purge/fluidizing gas and/or pull a high vacuum to remove excess quantities of the second reagent and reaction by-products. 6. Repeat steps 2-5 until desired coating thickness is obtained.

As mentioned, the same material may be used as the purge/fluidizing gas and each carrier gas. It is also possible to use different materials.

Analogous patterns are used when the film-forming reaction involves more than two reagents, or when a catalyzed reaction system is used. An example of a catalyzed reaction system is described below.

Such atomic layer controlled growth techniques permit the formation of deposits of up to about 0.3 nm in thickness per reaction cycle, and thus provide a means of extremely fine control over deposit thickness. The reactions are self-limited, and in most instances can be repeated to sequentially deposit additional layers of the deposited material until a desired thickness is achieved.

It is preferred to treat the particles before initiating the reaction sequence to remove volatile materials that may be absorbed onto the particle surface. This is readily done by exposing the particles to elevated temperatures and/or vacuum. Also, in some instances a precursor reaction may be performed to introduce desirable functional groups onto the surface of the particle.

Reaction conditions are selected mainly to meet two criteria. The first criterion is that the reagents are gaseous under the conditions of the reaction. Therefore, temperature and pressure conditions are selected such that the reactants are volatilized. The second criterion is one of reactivity. Conditions, particularly temperature, are selected such that the desired reaction between the film-forming reagents (or, at the start of the reaction, the first-introduced reagent and the particle surface) occur at a commercially reasonable rate.

The temperature of the reactions may range from 250-700° K. The temperature is preferably no greater than about 475° K. and more preferably no greater than 425° K. when the particle being coated is a phosphor rather than simply a particle of the host material. Temperatures in excess of these tend to cause diffusion of the luminescent centers from the crystalline lattice of the host material, which destroys or diminishes the ability of the particle to emit light.

Specific temperature and pressure conditions will depend on the particular reaction system, as it remains necessary to provide gaseous reactants. Subatmospheric pressures will normally be required.

A suitable apparatus for conducting the ALD reaction is one which permits the particles to become separated so that all particle surfaces become exposed to the reagents. One convenient method for exposing the base particles to the reagents is to form a fluidized bed of the particles, and then pass the various reagents in turn through the fluidized bed under reaction conditions. Methods of fluidizing particulate materials are well known, and generally include supporting the particles on a porous plate or screen. A fluidizing gas is passed upwardly through the plate or screen, lifting the particles somewhat and expanding the volume of the bed. With appropriate expansion, the particles behave much as a fluid. The reagents can be introduced into the bed for reaction with the surface of the particles. In this invention, the fluidizing gas also can act as an inert purge gas for removing unreacted reagents and volatile or gaseous reaction products.

In addition, the reactions can be conducted in a rotating cylindrical vessel or a rotating tube. A rotating reactor comprises a hollow tube that contains the base particles. The reactor may be held at an angle to the horizontal, so that the particles pass through the tube through gravitational action. In such a case, the reactor angle determines the flow rate of the particulate through the reactor. The reactor can be rotated in order to distribute individual particles evenly and expose all particles to the reactants. The reactor design permits the substrate particles to flow in a near plug-flow condition, and is particularly suitable for continuous operations. The rotating cylindrical vessel can also be sealed on both ends and have porous metal walls that allow the gases to flow in and out of the rotating cylindrical vessel. This rotary reactor is convenient for static reactant exposures and batch processing of phosphor particles.

The progress of the reaction can be monitored using techniques such as transmission Fourier transform infrared techniques, transmission electron spectroscopy, scanning electron microscopy, Auger electron spectroscopy, x-ray fluorescence, X-ray photoelectron spectroscopy and x-ray diffraction.”

“The particles used as substrates in this invention are . . . phosphor particles, i.e. particles that include both host material and luminescent centers and emit photons in response to the application of a particular type of excitation energy . . . . ”

“The particle contains some surface functional group which can serve as a site through which the first-applied ALD reagent can become bonded to the substrate particle. Useful functional groups are typically an M—H, M—O—H, M—S—H or M—N—H group, where M represents an atom of a metal or semi-metal. If necessary, these sites can be introduced onto the particle surface through various preparative methods . . . . ”

The phosphor is in the form of a particulate. The size of the particles may range from 1 to 50 μm. The particle size distribution of phosphor particles in the blends used in this disclosure is represented by a d50 ranging from 3.0-9.0 microns.

The “ALD coatings are those which can be applied via an ALD process at a temperature no higher than 475° K., and especially 425° K. or less . . . . ”

“The [coating] film is preferably transparent or nearly transparent to the photons emitted by the underlying phosphor particle, and forms a barrier to air, moisture and/or other ambient materials from which the underlying particle is to be protected . . . . ”

“The thickness of the applied films typically will be in the range of about 1 to about 500 nm . . . . ” “Film thickness is controlled via the number of reaction cycles that are performed.”

“The particulate is preferably non-agglomerated after the inorganic material is deposited. By “non-agglomerated”, it means that the particles do not form significant amounts of agglomerates during the process of coating the substrate particles. Particles are considered to be non-agglomerated if (a) the average particle size does not increase more than about 5%, preferably not more than about 2%, more preferably not more than about 1% (apart from particle size increases attributable to the coating itself) as a result of depositing the coating, or (b) if no more than 2 weight %, preferably no more than 1 weight % of the particles become agglomerated during the process of depositing the inorganic material.

In preferred embodiments, the deposits of inorganic material form a conformal coating. By “conformal” it is meant that the thickness of the coating is relatively uniform across the surface of the particle (so that, for example, the thickest regions of the coating are no greater than 3× (preferably no greater than 2×., especially no greater than 1.5×) the thickness of the thinnest regions), so that the surface shape of the coated substrate closely resembles that of the underlying substrate surface. Conformality is determined by methods such as transmission electron spectroscopy (TEM) that have resolution of 10 nm or below. Lower resolution techniques cannot distinguish conformal from non-conformal coatings at this scale. The desired substrate surface is preferably coated substantially without pinholes or defects.”

The phosphor-containing layer 14 is provided on the lamp as follows. The powder of phosphor particles is blended if there is more than one phosphor. At least one phosphor coated using atomic layer deposition (ALD) is used in the phosphor mixture, or if only a single phosphor is used, it is ALD coated. ALD coated phosphor particles can be mixed with non-ALD coated phosphor particles. Additional additives may be included in the phosphor blend and can include a dispersion vehicle, binder and one or more of various known non-luminescent additives, including, e.g., alumina, calcium phosphate, thickeners, dispersing agents, and certain borate compounds as are known in the art. In the coating procedure typically the various phosphor powders are blended by weight. The resulting powder is then dispersed in a water based system (which may contain other additives as are known in the art, including adherence promoters such as hydroxyethylcellulose or fine non-luminescent particles of alumina or calcium pyrophosphate) optionally with a dispersing agent as is known in the art. A thickener may be added, typically polyethylene oxide. The suspension is then typically diluted with deionized water until it is suitable for producing a coating of the desired thickness or coating weight. The phosphor blend suspension is then applied as a coating to the inside of the glass tube (preferably by pouring the suspension down the inside of a vertically-held tube or pumping the suspension up into same) and heated by forced air until dry, as is known in the art. After the first thin coat or layer is applied, additionally desired thin coats or layers may be applied in the same manner, carefully drying each coat before the next coat is applied. In the heating stage the components other than the phosphor are driven off, leaving only the phosphor behind. The thin layers are built up until the total or cumulative coating thickness is sufficient to absorb substantially all of the UV light produced by the arc. Although not intended to be limiting, this typically corresponds to a thickness of between about 1 and about 25 microns, preferably between 1 and 10 microns, depending on the exact composition of the phosphor blend and the particle size of the phosphors. The phosphor-containing underlying layer is applied so that the weight of phosphor in the layer (the “coating weight”) can be, for example, 0.5-4, more specifically, 0.8-3.5 mg/cm².

In one aspect, the lamp has no more than one layer inside the glass envelope, this one layer being the described phosphor-containing layer. This layer faces the arc or is closer to the arc than is the glass envelope. The lamp may have a UV reflecting barrier layer 24 between the phosphor-containing layer 18 and the inner surface 14 of the glass tube 12, for example, comprising alumina or silica. In this case the phosphor-containing layer is still closer to the arc than the barrier layer and is an inner surface of the tube.

The disclosure will now be described by reference to the following example, which should not be used in any way to limit the invention that is described by the following claims.

### Example

Table 2 simulates lamp performance at 100 hour burning. A spreadsheet is used to mathematically sum from a library of spectra to simulate lamp performance. The individual spectra were obtained for unblended one component phosphors for each of red, green and blue and the properties were measured for lamps coated with these phosphors at 100 hours of burning. Phosphor blends were then simulated using the spreadsheet by using proportions of each of the red, green and blue one component blends (spectral percentages) to produce a white blend and estimating the LPW and CRI for lamps using the blend based on the measured LPW and CRI for the lamps that include only one of each component. This gives reasonable estimates of the spectra and the LPW. The CRI values shown for R1-14 are calculated from the spectra with standardized formulas described above. To make phosphor compositions from the blends and their spectral percentages, one would start out with blends using the spectral % of each component as a wt % value. Then, based on measured CCT and color points one would adjust the wt % of the components of the blend in a manner known to those skilled in the art to achieve the desired CCT and color point of the blend.

YVP loses lumens very quickly—as currently made for comparison purposes (“old YVP”). This is believed to be due to a reaction with Hg in the lamp. The 0 hr lumens are measured when the lamp has not burned very long, so presumably there hasn't been much reaction. If the mercury reaction could be stopped or inhibited, as by using the ALD coating on YVP, the 100 hr lumens could be estimated to be close to the 0 hr lumens. Since the 0 hr lumens is what was measured, that value was used in the spreadsheet simulation that produced the values of Table 2 for 100 hour lamp burning. The other phosphors of this disclosure that are intended to be coated (see Phosphors to be Coated above) do not have this fast reaction with Hg, so their 100 hr LPW values would be expected to be close to being the same coated or uncoated. There are other phosphor/lamp interactions that take place over a longer period of time that might be slowed by the ALD coating. That is, it is desirable to coat those phosphors described herein other than YVP (Phosphors to be Coated above), even though there may not be a difference at 100 hr of lamp burning. These other phosphors may be improved by presumably having an increased LPW at longer life.

The phosphors in the blends described in Table 2 are as follows as shown in Table 1 below. The amounts of each phosphor given in Table 1 are spectral % as discussed above. A fraction of each unblended spectra are blended together to produce the white blends of the simulation. CBM is gadolinium magnesium pentaborate activated with cerium and manganese.

TABLE 1

| 3000K | | 5000K | |
|---|---|---|---|
| New YVP | | New YVP | |
| YVP | 54% | YVP | 32% |
| LAP | 41% | LAP | 49% |
| BAM | 5% | BAM | 19% |
| Old YVP | | Old YVP | |
| YVP | 67% | YVP | 45% |
| LAP | 30% | LAP | 40% |
| BAM | 3% | BAM | 15% |
| Std YEO | | Std YEO | |
| YEO | 49% | YEO | 28% |
| LAP | 45% | LAP | 51% |
| BAM | 6% | BAM | 21% |
| CBM | | CBM | |
| CBM | 67% | CBM | 44% |
| LAP | 30% | LAP | 40% |
| BAM | 3% | BAM | 16% |

The simulated properties of the white blends are given in Table 2 below.

TABLE 2

| | Ri | | | | | | | |
|---|---|---|---|---|---|---|---|---|
| | 3000K | | | | 5000K | | | |
| | LPW | | | | LPW | | | |
| | 94.3 | 60.7 | 84.0 | | 91.2 | 69.5 | 85.3 | |
| | Std | Old | New | 63.0 | Std | Old | New | 71.3 |
| | YEO | YVP | YVP | CBM | YEO | YVP | YVP | CBM |
| 1 | 97.3 | 86.2 | 85.8 | 94.0 | 92.2 | 96.6 | 96.8 | 92.6 |
| 2 | 98.1 | 96.7 | 96.2 | 97.5 | 91.7 | 92.4 | 92.7 | 90.2 |
| 3 | 61.0 | 50.4 | 51.3 | 49.6 | 57.7 | 52.3 | 52.8 | 51.7 |
| 4 | 93.1 | 86.3 | 86.7 | 89.4 | 85.6 | 88.8 | 89.1 | 86.6 |
| 5 | 92.3 | 95.5 | 95.7 | 94.2 | 83.0 | 87.0 | 87.3 | 84.4 |
| 6 | 90.5 | 91.8 | 92.8 | 80.9 | 76.2 | 76.6 | 77.1 | 71.3 |
| 7 | 90.0 | 89.7 | 90.4 | 84.6 | 91.2 | 88.1 | 88.5 | 85.5 |
| 8 | 68.1 | 93.4 | 94.0 | 84.0 | 79.2 | 91.4 | 91.8 | 87.3 |
| 9 | 5.3 | 67.5 | 68.2 | 92.0 | 24.1 | 72.4 | 72.9 | 97.3 |
| 10 | 64.4 | 64.6 | 66.1 | 61.5 | 47.5 | 47.4 | 48.3 | 46.0 |
| 11 | 80.6 | 88.4 | 89.0 | 83.4 | 64.7 | 68.6 | 68.9 | 66.1 |
| 12 | 67.0 | 65.9 | 68.1 | 59.6 | 55.1 | 55.7 | 56.1 | 53.3 |
| 13 | 92.1 | 83.9 | 83.3 | 90.9 | 93.5 | 94.7 | 94.7 | 93.1 |
| 14 | 72.2 | 65.0 | 65.5 | 66.8 | 71.9 | 68.3 | 68.5 | 69.2 |
| CRI | 86.3 | 86.3 | 86.6 | 84.3 | 82.1 | 84.1 | 84.5 | 81.2 |
| (Rₐ) | | | | | | | | |

Table 2 explains why the particular phosphors disclosed herein were chosen for protection with the thin coating achieved using the ALD process. Referring to the standard YEO blend as an example, which produced white light having a CCT of 3000° K, the LPW was about 94 and the CRI was about 86 which is good. However, the CRI for the R9 value for deep red was low at 5.3. The deep red color of R9 would be more noticeable if the CRI at R9 was increased. The average CRI shown at the bottom of the table (Rₐ) is calculated for the CRIs of R1-R8 (and does not include the CRI for R9). Therefore, even though the average reported CRI for standard YEO was about 86, it does not reflect the very low CRI at the R9 level. A phosphor used instead of standard YEO in view of standard YEO's shortcomings, is CBM. CBM exhibited a good CRI at R9 of 92. However the LPW of CBM is 63, rather than the 94 for standard YEO, which is poor. The old (non-ALD coated) YVP blend exhibited a better R9 CRI of about 68 but the LPW was about 61, which was even lower than the LPW for CBM.

Therefore, it was believed that the CRI of 5 at R9 for YEO could be improved by careful selection of the phosphor to ALD coat. YVP was chosen as a phosphor to protectively ALD coat (referred herein as “new YVP”) since it is expected to have a higher CRI at R9 compared to that of standard YEO. The CRI at R9 for the new YVP was expected to be reasonable at about 68 with good LPW at 84. This “new YVP's” R9 CRI is expected to be dramatically better than for the standard YEO phosphor; and it is expected to have a better LPW than that of CBM. The protective ALD coating is expected to result in an increase of LPW from 61 for old YVP to a LPW of 84 for new YVP. Note that similar results are expected to be seen for the blends having a CCT of 5000° K.

Many modifications and variations of the invention will be apparent to those of ordinary skill in the art in light of the foregoing disclosure. Therefore, it is to be understood that, within the scope of the appended claims, the invention can be practiced otherwise than has been specifically shown and described.

What is claimed is:

1. A fluorescent lamp comprising:
an envelope that is light transmitting;
means for providing a discharge inside said envelope;
a discharge-sustaining fill of mercury and an inert gas sealed inside said envelope;
a phosphor-containing layer coated inside said envelope, said phosphor-containing layer being comprised of particles comprising phosphor selected from the group consisting of:
zinc germanium silicate; strontium aluminate; strontium fluorophosphate; strontium magnesium orthophosphate; barium magnesium aluminate; yttrium vanadate, and combinations thereof; and
a coating on individual said particles of at least one of said phosphor, said coating being selected from the group consisting of alumina, yttria, lanthanum oxide, magnesium aluminate spinel, magnesium oxide, and combinations thereof.

2. The fluorescent lamp of claim 1 wherein said yttrium vanadate comprises yttrium vanadate activated with europium, yttrium vanadate phosphate activated with europium, and combinations thereof.

3. The fluorescent lamp of claim 1 wherein said zinc germanium silicate comprises zinc germanium silicate activated with manganese; said strontium aluminate comprises strontium aluminate activated with europium; said strontium fluorophosphate comprises strontium fluorophosphate activated with antimony and manganese; said strontium magnesium orthophosphate comprises strontium magnesium orthophosphate activated with tin; and said barium magnesium aluminate comprises barium magnesium aluminate activated with europium or barium magnesium aluminate activated with europium and manganese.

4. The fluorescent lamp of claim 1 wherein said coating comprises magnesium aluminate spinel.

5. The fluorescent lamp of claim 2 wherein said coating comprises magnesium aluminate spinel.

6. The fluorescent lamp of claim 1 wherein said means for providing a discharge inside said envelope comprises electrodes spaced apart from each other and disposed at ends of said envelope.

7. The fluorescent lamp of claim 1 wherein said coating on said particles has a thickness of not more than 500 nm and is made using atomic layer deposition.

8. The fluorescent lamp of claim 7 wherein said coating on said particles has a thickness of not more than 100 nm.

9. A fluorescent lamp comprising:
an envelope that is light transmitting;
means for providing a discharge inside said envelope;
a discharge-sustaining fill of mercury and an inert gas sealed inside said envelope;
a phosphor-containing layer coated inside said envelope, said phosphor-containing layer being comprised of the following blend of phosphors:
yttrium vanadate and at least one phosphor selected from the group consisting of barium magnesium aluminate, (barium, strontium or calcium)chloroapatite, strontium aluminate, halophosphate and combinations thereof; and
a coating on individual particles of said blend that are comprised of said yttrium vanadate, said coating being selected from the group consisting of alumina, yttria, lanthanum oxide, magnesium aluminate spinel, magnesium oxide and combinations thereof.

10. The fluorescent lamp of claim 9 wherein said coating comprises magnesium aluminate spinel.

11. The fluorescent lamp of claim 9 wherein said means for providing a discharge inside said envelope comprises electrodes spaced apart from each other and disposed at ends of said envelope.

12. The fluorescent lamp of claim 9 wherein said yttrium vanadate comprises at least one of yttrium vanadate activated with europium, yttrium vanadate phosphate activated with europium, and combinations thereof.

13. The fluorescent lamp of claim 9 wherein said barium magnesium aluminate comprises at least one of barium magnesium aluminate activated with europium (BAM) and barium magnesium aluminate activated with europium and manganese (BAMn), said strontium aluminate comprises strontium aluminate activated with europium (Sr₄Al₁₄O₂₅:Eu), said halophosphate comprises Ca₁₀(PO₄)₆(F,Cl)₂:Sb,Mn; where one or both of Cl and Mn may be zero and said (barium, strontium or calcium)chloroapatite comprises (barium, strontium or calcium)chloroapatite activated with europium (SECA).

14. The fluorescent lamp of claim 9 wherein said coating on said particles has a thickness of not more than 500 nm and is made using atomic layer deposition.

15. The fluorescent lamp of claim 14 wherein said coating on said particles has a thickness of not more than 100 nm.

16. The fluorescent lamp of claim 9 wherein said phosphors further comprise Y₂O₃:Eu³⁺(YEO).

17. A fluorescent lamp comprising:
an envelope that is light transmitting;
means for providing a discharge inside said envelope;
a discharge-sustaining fill of mercury and an inert gas sealed inside said envelope;
a phosphor-containing layer coated inside said envelope, said phosphor-containing layer being comprised the following blend of phosphors:
at least one of yttrium vanadate activated with europium or yttrium vanadate phosphate activated with europium;
at least one first phosphor selected from the group consisting of barium magnesium aluminate activated with europium (BAM), barium magnesium aluminate activated with europium and manganese (BAMn), (barium, strontium or calcium)chloroapatite activated with europium (SECA), strontium aluminate activated with europium, halophosphate and combinations thereof; and
at least one second phosphor selected from the group consisting of lanthanum phosphate activated with cerium and terbium (LAP), magnesium cerium aluminate phosphor activated with terbium (CAT), gadolinium magnesium borate activated with cerium and terbium (CBT), barium magnesium aluminate activated with europium and manganese (BAMn) and combinations thereof; and
a coating on individual particles of said blend that are comprised of said yttrium vanadate activated with europium or said yttrium vanadate phosphate activated with europium, or a combination thereof, said coating being selected from the group consisting of alumina, yttria, lanthanum oxide, magnesium aluminate spinel, magnesium oxide and combinations thereof.

18. The fluorescent lamp of claim 17 wherein said coating comprises magnesium aluminate spinel.

19. The fluorescent lamp of claim 17 wherein said means for providing a discharge inside said envelope comprises electrodes spaced apart from each other and disposed at ends of said envelope.

20. The fluorescent lamp of claim 17 wherein said coating on said particles has a thickness of not more than 500 nm and is made by atomic layer deposition.

21. The fluorescent lamp of claim 20 wherein said coating on said particles has a thickness of not more than 100 nm.

22. The fluorescent lamp of claim 17 wherein said phosphors further comprise Y₂O₃:Eu³⁺(YEO).

23. A fluorescent lamp comprising:
an envelope that is light transmitting;
means for providing a discharge inside said envelope;
a discharge-sustaining fill of mercury and an inert gas sealed inside said envelope;
a phosphor-containing layer coated inside said envelope, said phosphor-containing layer being comprised the following blend of phosphors:
at least one of yttrium vanadate activated with europium or yttrium vanadate phosphate activated with europium; and at least one of the following first and second phosphors:
at least one said first phosphor having a blue emission peak in the range of 400-460 nm; and
at least one said second phosphor having a green emission peak in the range of 500-560 nm; and
a coating on individual particles of said blend that are comprised of said yttrium vanadate activated with europium or said yttrium vanadate phosphate activated with europium, or a combination thereof, said coating being selected from the group consisting of alumina, yttria, lanthanum oxide, magnesium aluminate spinel, magnesium oxide and combinations thereof.

24. The fluorescent lamp of claim 23 wherein said coating on said particles has a thickness of not more than 500 nm and is made by atomic layer deposition.

25. The fluorescent lamp of claim 23 wherein said phosphors further comprise Y₂O₃:Eu³⁺(YEO).
